(19) United States
(12) Patent Application Publication
(10) Pub. No.: US 2026/0236471 A1
(43) Pub. Date: Aug. 13, 2026

(54) MECHANISM FOR MANAGING AND RETRIEVING METADATA FROM AN ENTERPRISE-WIDE DATABASE

(71) Applicant: American Express Travel Related Services Company, Inc., New York, NY (US)

(72) Inventors: Purvi SHAH, East Brunswick, NJ (US); Vinay DHINGRA, Gurgaon (IN); Ashank GUPTA, Delhi (IN); Vaibhav GUPTA, New Delhi (IN); Anuj GUPTA, Gurgaon (IN); Aditya Kumar MISHRA, Patna (IN); Pratiti SHRIVASTAVA, Jersey City, NJ (US); Mayank KAPOOR, Jersey City, NJ (US)

(73) Assignee: American Express Travel Related Services Company, Inc., New York, NY (US)

(21) Appl. No.: 19/048,523

(22) Filed: Feb. 7, 2025

(51) Int. Cl. G06F 16/2455; G06F 16/2453; G06F 16/28

(52) U.S. Cl. CPC G06F 16/2455; G06F 16/24534; G06F 16/285

(57) ABSTRACT

A system, method, and computer program product are provided for managing and retrieving metadata from an enterprise-wide database. An implementation receives a search query from a user. The implementation then generates an updated search query by at least providing the search query into a natural language processing engine. The implementation then retrieves a collection of metadata from a database by at least querying a search engine with the updated search query. The implementation then generates a collection of ranked metadata by at least providing, associated with the collection of metadata, a usage history of a table or attribute access by the user over a period of time into a ranking engine. The implementation then selects one or more top-ranked metadata of the collection of ranked metadata to generate a result of the updated search query.

### BACKGROUND

The domain of decision-making is heavily dependent on data, which creates a need for redefining the art of data discovery. In the financial services industry, particularly within the dynamic and data-rich environment of enterprise companies, such as a bank holding company, efficient data management is paramount. As data volumes grow exponentially, so does the importance of metadata, which serves as the vital bridge connecting raw data to actionable insights.

### BRIEF DESCRIPTION OF THE FIGURES

The accompanying drawings are incorporated herein and form a part of the specification.

FIG. 1 is a block diagram of a metadata retrieval system, according to aspects of the present disclosure.

FIG. 2 is a block diagram of a NLP engine, according to aspects of the present disclosure.

FIG. 3 is a block diagram of a search engine, according to aspects of the present disclosure.

FIG. 4 is a block diagram of a ranking engine, according to aspects of the present disclosure.

FIG. 5 is an operational framework of a metadata retrieval system, according to aspects of the present disclosure.

FIG. 6 is an example illustrating a NLP cleanse performed by a syntactic processor, according to aspects of the present disclosure.

FIG. 7 is an example illustrating a tailored search performed by a tailored search engine, according to aspects of the present disclosure.

FIG. 8 is an example illustrating a tailored search performed by a tailored search engine with numerical input query, according to aspects of the present disclosure.

FIG. 9 is an example illustrating a tailored search performed by a tailored search engine with categorical search query, according to aspects of the present disclosure.

FIG. 10 is an example illustrating a tailored search performed by a tailored search engine with specific column search query, according to aspects of the present disclosure.

FIG. 11 is an example illustrating a tailored search performed by a tailored search engine with full text search query, according to aspects of the present disclosure.

FIG. 12 is an example illustrating an insightful ranking performed by an insightful ranking engine, according to aspects of the present disclosure.

FIG. 13 is an example illustrating an insightful ranking performed by an insightful ranking engine, according to aspects of the present disclosure.

FIG. 14 is a flowchart illustrating a method for managing and retrieving metadata from an enterprise-wide database, according to some embodiments.

FIG. 15 illustrates an example computer system useful for implementing various aspects of the present disclosure.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product aspects, and/or combinations and sub-combinations thereof, for managing and retrieving metadata from an enterprise-wide database.

Implementations described herein describes a metadata retrieval system, for managing and retrieving metadata, tailored to meet the specific data management needs of from an enterprise-wide database in any enterprise companies within the financial services industry. Enterprise companies, such as bank holding companies, typically have a repository of substantial data holdings and face a challenge managing and accessing the ever-expanding universe of metadata linked to its extensive collection of tables and attributes. Metadata provides descriptions, classifications, and relationships for each data element. The complexity of managing the enormous data landscape within such systems necessitate an effective solution for navigating this metadata ecosystem. Searching for relevant metadata in such large datasets becomes challenging especially as those datasets continue to expand.

To tackle these technological challenges, embodiments described herein describes a metadata retrieval system in which the metadata retrieval system includes, but is not limited to, a natural language processing (NLP) engine, a specialized metadata search engine, and/or a ranking engine. For example, NLP engine may extract information from a sentence, whether typed or spoken, and translate it into structured data. The NLP engine may be used for NLP tasks to improve syntactical robustness of the user searching query. After the NLP engine processes or refines the user search query, the metadata search engine may then retrieve relevant metadata from a database in response to the user search query. In some aspects, the metadata search engine may be implemented as a software system that can provide hyperlinks and other relevant information based on a user's query. In some aspects, the metadata search engine may generate a comprehensive list of rules or criteria to adaptively process different user search queries and then fast index and search database using the user search query (e.g., the updated or refine user search query obtained from the NLP engine). In addition, after retrieving relevant metadata from the metadata search engine using the updated or refined user search query from the NLP engine, the ranking engine may rank the retrieved metadata based on usage history in which items that are frequently accessed or relevant may be prioritized for the future results. This combination and collaboration of a NLP engine, a metadata search engine, and a ranking engine manages and retrieves metadata from an enterprise-wide database.

The embodiments described herein, with a NLP engine, improve upon conventional systems by performing at least one of a special character removal, a stopwords removal, an acronym expansion, a segmentation, and/or a lemmatization. The NLP engine may correct the user search query when the user has provided misspelled input search query. For example, the NLP engine may also enable computers and digital devices to recognize, understand, generate, and/or update text and speech of the input search query by combining computational linguistics—the rule-based modeling of human language—together with statistical modeling, machine learning (ML) and deep learning. NLP engine may use generative artificial intelligence (AI), including but not limited to, large language models (LLMs) to understand the user searching query or request and then transform or update the user searching query. NLP engine may analyze the user searching query to quickly identify relevant information in the user query, and organize the user query in a structured way for subsequent querying process. In addition, the NLP engine, in conjunction with LLMs, may support multimodal user searching query, in which possible modalities may be received, including but not limited to audio, text, images, and/or video. For example, NLP engine can be used to communicate with a user through text or voice to understand what the user is typing and respond appropriately.

The implementations described herein, with a tailored search engine, provide a tailored search engine to increase the system capability by developing comprehensive rules for processing an input user search query. For example, the specialized or tailored search engine may define a comprehensive list of the possible search criteria and rules in the field, making the search engine search for metadata adaptive to different types of search queries. For example, the tailored search engine may support different query types, including but not limited to, numerical input search query, categorical/column search query, and/or full text search query. The tailored search engine may receive other search criteria, including but not limited to, product, classification, source system, and/or any customizable parameters. The tailored search may also support fast indexing and searching of a large scale database by organizing metadata information into separate elastic search indexes, one for each level of hierarchical metadata levels, including but not limited to, Table, Attribute and Combined. Provided search capabilities at multiple different levels, these separate elastic search indexes may serve as a tool to navigate the user search query to specific data layouts that are stored and indexed in the database.

Indexes with hierarchical metadata levels may be used to quickly locate data without having to search every row in a database table when the database table is accessed. The hierarchy of metadata levels with Table, Attribute and Combined, may cover the full layout or structures of data index in database. With a comprehensive coverage of the structural data index, such hierarchy of metadata level may efficiently and effectively locate relevant data at run time. A hierarchy of these levels may also inherit all of the metadata of the attribute it uses—this may also allow the metadata for attributes and levels to be reused in many hierarchies. In addition, indexes may be created as a basis for both rapid random lookups and efficient access of ordered/sorted records.

Implementations described herein, with a ranking engine, introduce an element of adaptive learning and user-centricity—the ranking engine may rank the metadata retrieval results using an adaptive usage history (e.g., user dynamic fetching logs). For example, the implementations described herein ensure that the most frequently accessed attribute & table based on the data fetched by users during a specific period of time may be weighted as a higher position in the search results by sorting importance metrics associated with the metadata search results within a period of time. For example, implementations described herein may use artificial intelligence (AI) to provide a dynamic or adaptive ranking of the search results by finding trends in the users' behavior. Based on the query and the position of the search result, the ranking engine may improve the searching relevance by boosting searching results that are rising in popularity (e.g., has more user accesses). On the other hand, dynamic ranking can also demote irrelevant results. For example, if users frequently choose surgical masks when searching for “mask”, it may increase the ranking of surgical masks in future results. This may lead to a more relevant search experience and can result in a higher conversion rate without having to create rules or use optional filters to tweak relevance, thereby dynamically increasing the search relevancy for the users.

In summary, implementations described herein are directed to a metadata retrieval system that comprises various modules for performing different functions of the present disclosure. Examples of these functions include, but are not limited to, a NLP cleanse, a tailored search, and an insightful ranking. The strategic and refined use of tailored search and NLP cleanse may be tagged with an optimized insightful ranking. This custom combination may offer a tailored and optimized platform for efficient metadata retrieval, empowering the users with an agile, precise, and intelligent means of managing and retrieving metadata within the vast database. These and other aspects of the present disclosure will be described in further detail below with respect to the accompanying drawings.

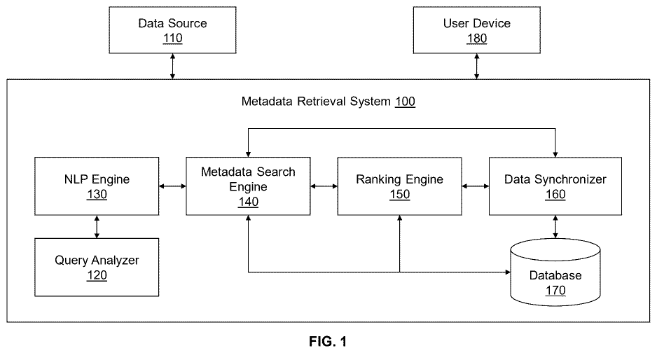

FIG. 1 is a block diagram of metadata retrieval system 100, according to aspects of the present disclosure. In some aspects, metadata retrieval system 100 may include, but is not limited to, a query analyzer 120, a NLP engine 130, a metadata search engine 140, a ranking engine 150, a data synchronizer 160, and/or a database 170. NLP engine 130 may be configured to interface with query analyzer 120, and/or metadata search engine 140. Metadata search engine 140 may be configured to interface with NLP engine 130, ranking engine 150, a data synchronizer 160, and/or database 170. Ranking engine 150 may be configured to interface with metadata search engine 140, data synchronizer 160, and/or database 170.

In some aspects, data source 110 may be a separate computing platform including but not limited to smartphones, tablet computers, laptop computers, desktop computers, web browsers, and/or other computing devices, apparatuses, systems, or platforms. In some aspects, data source 110 may transmit information to metadata retrieval system 100 either in a wired or wireless manner and may be, for example, the Internet, a Local Area Network, or a Wide Area Network. The transmission may utilize a network protocol, such as, for example, a hypertext transfer protocol (HTTP), a transmission control protocol (TCP)/Internet protocol (IP) protocol, Ethernet, or an asynchronous transfer mode.

In some aspects, user device 180 may be also a separate computing platform including but not limited to smartphones, tablet computers, laptop computers, desktop computers, web browsers, and/or other computing devices, apparatuses, systems, or platforms. In some aspects, user device 180 may transmit information to metadata retrieval system 100 either in a wired or wireless manner and may be, for example, the Internet, a Local Area Network, or a Wide Area Network. The transmission may utilize a network protocol, such as, for example, a hypertext transfer protocol (HTTP), a transmission control protocol (TCP)/Internet protocol (IP) protocol, Ethernet, or an asynchronous transfer mode.

In some aspects, metadata retrieval system 100 may receive data from data source 110. The data from data source 110 may include, but is not limited to, new or updated metadata. The metadata may refer to “data about data.” Metadata may also be defined as the data providing information about one or more aspects of the data-it may be used to summarize basic information about data that can make tracking and working with specific data easier. In some aspects, metadata retrieval system 100 may also receive an input search query from user device 180. The input search query may refer to a word or phrase that a user types into metadata retrieval system 100 to find information that answers an inquiry or question. The search queries may be made up of keywords that generate a list of relevant results of the metadata.

After metadata retrieval system 100 receives search query from user device 180, query analyzer 120 may be triggered by the query characteristics that matches predefined criteria to analyze the contexts and/or types of the search query. These criteria may be determined based on a list of factors, including but not limited to, types of query input, the system capabilities, the computational resource, and/or any transmission effects.

Query analyzer 120 may, based on the criteria, monitor and analyze the search query from user device 180 to help improve database performance. In some aspects, query analyzer 120 may support functionalities, including but not limited to, monitor search query statements, identify search performance issues, improve quality of search query, and/or plan for system search capacity needs.

After the search query user device 180 is analyzed at query analyzer 120, query analyzer 120 may transmit the search query to a NLP engine 130. NLP engine 130 may be configured to perform a comprehensive set of syntactical analysis steps, including but not limited to, a special character removal, a stopwords removal, an acronym expansion, a segmentation, and/or a lemmatization. In some aspects, NLP engine 130 may receive new or updated metadata in which the new or updated metadata may provide a continuous synchronization of metadata retrieval system 100 with a continuous input of metadata within a periodical time. NLP engine 130 may process the new or updated metadata in the same syntactical manner (e.g., syntactical analysis steps) as the received search query but the syntactical processing could also be different.

After the search query and the new and/or updated metadata are processed at NLP engine 130, NLP engine 130 may transmit the processed search query and/or the processed metadata to a metadata search engine 140. Metadata search engine 140 may be configured to index metadata and run the processed search queries to retrieve any relevant metadata from a database 170. The search engine may provide customized search types for different search queries based on the query analysis performed at query analyzer 120 that discerns the query type and/or context. In some aspects, metadata search engine 140 may store the new metadata from data source 110 into database 170 and/or update the metadata in database 170 using updated (e.g., processed) metadata obtained from NLP engine 130. Metadata search engine 140 may also transmit the new or updated metadata to a data synchronizer 160 for any data synchronization. For example, data synchronizer 160 may at least one of use version control, file synchronization tools, distributed file systems, and/or mirror computing to synchronize the changes made to more than one copy of a file (e.g., by one or more users) at a time. In some aspects, data synchronizer 160 may help clean up metadata by removing invalid characters, standardizing formatting, and ensuring that fields are filled out correctly. Data synchronization can ensure the metadata collected by metadata retrieval system 100 is consistent across multiple platforms or clients to prevent discrepancies.

After running the search query in metadata search engine 140, metadata search engine 140 may transmit the search result to a ranking engine 150. Ranking engine 150 may be configured to sort the metadata of the search result from metadata search engine 140. Ranking engine 150 may assign importance metrics or score to the metadata based on usage history (e.g., data of an attribute fetched by users during a period of time) associated with each attribute of each table and stored in database 170. Ranking engine 150 may prioritize items that are frequently accessed by using the computed metrics or score of the metadata. In some aspects, ranking engine 150 may cluster the metadata within categories and the priorities may be determined as ranking of the search results utilizing the sorting metric and/or score to resolve conflicts within the results with same priority. In some aspects, ranking engine 150 may select the top-rank metadata as the retrieval results of metadata retrieval system 100 and output the retrieval results to the user and/or store as a retrieval record in database 170.

After obtaining the metadata retrieval results from ranking engine 150, ranking engine 150 may transmit the retrieval results to data synchronizer 160. Data synchronizer 160 may update the usage history associated with the retrieval results (e.g., the one or more top ranked metadata) in database 170. The updated usage history may be used by metadata retrieval system 100 to perform a new ranking of the metadata for a new search query in which the new search query may be received from user device 180 when a new search starts. In some aspects, the obtained metadata retrieval results may also be provided back or displayed to user device 180.

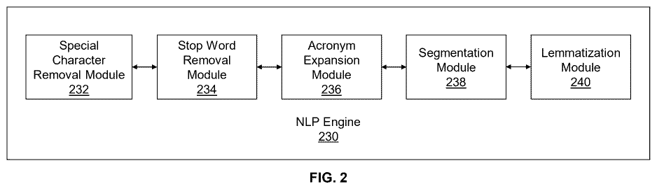

FIG. 2 is a block diagram of a NLP engine 230, according to aspects of the present disclosure. Within NLP engine 230, metadata may undergo a comprehensive set of syntactical analysis steps. In some aspects, NLP engine 230 may include, but is not limited to, a special character removal module 232, a stop word removal module 234, an acronym expansion module 236, a segmentation module 238, and/or a lemmatization module 240. NLP engine 230 shall be described with reference to metadata retrieval system 100 in FIG. 1. However, NLP engine 230 is not limited to that example aspect.

In some aspects, special character removal module 232 may be configured to eliminate special characters, including but not limited to, punctuation marks, symbols, and/or other non-alphanumeric characters from the text to ensure that these characters do not interfere with search queries or affect search results. For example, special character removal module 232 may make “Hello, world!” become “Hello world.” In some aspects, stop word removal module 234 may be configured to remove common stopwords, including but not limited to, “the”, “and”, “is”, “or”, “in” from the text to increase the relevance of the search query as these words may often be non-informative and may not contribute significantly to search relevance.

In some aspects, acronym expansion module 236 may be configured to expand acronyms (e.g., a specialized list of abbreviations) to their full forms to ensure clarity and consistency in the indexed data.

In some aspects, segmentation module 238 may be configured to segment strings into meaningful units to improve search accuracy and readability in which words or phrases may be concatenated without spaces. For example, “CustomerSupportTeam” may be segmented as “Customer Support Team.”

In some aspects, lemmatization module 240 may be configured to reduce words to their base or root forms which would be helpful to group words with different inflections or forms under a common root, for example, “running” and “ran” may both be reduced to “run,” ensuring that different variations of a word may be treated as one root form during searches.

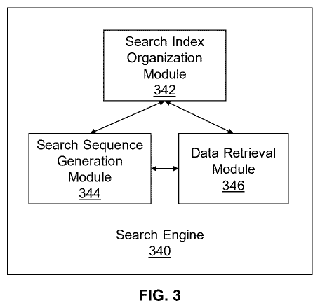

FIG. 3 is a block diagram of a search engine 340, according to aspects of the present disclosure. Within search engine 340, metadata retrieval system 100 may utilize elastic search for indexing data and running search queries. In some aspects, search engine 340 may be flexible open-source search and analytics engine, but it can be any search and analytics engines. In some aspects, search engine 340 may include, but is not limited to, a search index organization module 342, a search sequence generation module 344, and/or a data retrieval module 346. Search engine 340 shall be described with reference to metadata retrieval system 100 in FIG. 1. However, search engine 340 is not limited to that example aspect.

In some aspects, search index organization module 342 may be configured to organize metadata into database 170 when constructing a search engine database (e.g., part of database 170) by indexing and querying metadata table's hierarchical structures, contents, and/or attributes. In particular, search index organization module 342 may organize metadata into separate elastic search indexes, one for each level of hierarchical metadata levels, including but not limited to, Table, Attribute and Combined. For example, Table level is at the top-level view, offering a comprehensive understanding of metadata of tables within data ecosystem. Users can explore the structural layout of these tables to insights into their organization and relationships. The table name, for example, Transactions, may represent the name of the database table, which may uniquely identify it within database 170. For example, Attribute level, delving deeper, may provide users with granular information about individual attributes in a table. This Attribute level may offer technical specifications and business relevance details, equipping users with a deeper understanding of specific data elements. The attribute name, for example, TransactionID, Amount, Merchant, and/or CardholderID, may include a list of attribute names within the table, each representing a specific field of data. For example, Combined level, from a holistic perspective, may unify both table and attribute metadata, allowing users to navigate the interconnected web of data elements effortlessly.

In some aspects, search index organization module 342 may further be configured to organize the components of metadata to include, but is not limited to, a data type, an index, and/or a description of the metadata. The data type, for example, TransactionID (Integer), Amount (Decimal), Merchant (Text), CardholderID (Integer) may be associated with each attribute, indicating the type of data it can store (e.g., text, numbers, dates). The index, for example, an index on the TransactionID attribute for fast retrieval may represent details about indexes created on specific attributes to optimize data retrieval performance. The description may refer to a textual description or summary of the table's purpose and content, providing context for users.

In some aspects, search sequence generation module 344 may be configured to generate search sequence customized for different types of search query, including but not limited to, numeric input search query, specified category/column search query, and/or general full text search query. Search sequence generation module 344 may direct the user query to the appropriate search sequence, optimizing search precision of metadata retrieval system 100.

In some aspects, data retrieval module 346 may be configured to search relevant metadata in database 170 constructed by search index organization module 342. After obtaining generated search sequence from search sequence generation module 344, data retrieval module 346 may perform different search approaches, including but not limited to, keyword search, condition search, content search, vector search, and/or elastic search to retrieve relevant metadata in database 170. For example, the elastic search performed at data retrieval module 346 may organize data into units of information representing entities. Entities may be grouped into indices, similar to databases, based on their characteristics. Elastic search may then use inverted indices, a data structure that maps words to their entity locations, for an efficient search. Elastic search's distributed architecture may enable the rapid search and analysis of massive amounts of data with a real-time performance.

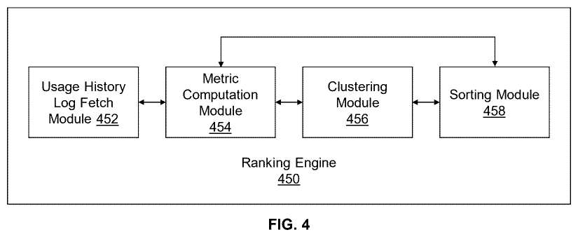

FIG. 4 is a block diagram of a ranking engine 450, according to aspects of the present disclosure. In some aspects, ranking engine 450 may include, but is not limited to, a usage history log fetch module 452, a metric computation module 454, a clustering module 456, and/or a sorting module 458. Ranking engine 450 shall be described with reference to metadata retrieval system 100 in FIG. 1. However, ranking engine 450 is not limited to that example aspect.

In some aspects, usage history log fetch module 452 may be configured to fetch any data logs stored in database 170 into metadata retrieval system 100 and these data logs include information such as the list of attributes, the user ID of the retriever, the timestamp, etc. These data logs may be utilized to compute the individual table or attribute usage in the form of factors, including but not limited to, distinct usage count, distinct user count, production environment use case count, and/or testing environment use case count. It would be appreciated by a person having ordinary skill in the art that those factors may be customizable in which any additional factors may be included. For example, distinct usage count may refer to a total number of times a particular table or attribute was fetched. Distinct user count may refer to a number of distinct users who have fetched a particular table or attribute. Production environment use case count may refer to a number of unique use cases in the production environment which utilize that table or attribute. Testing environment use case count may refer to a number of unique use cases in the testing environment which utilize that table or attribute. Usage history log fetch module 452 may transmit the fetched data logs and/or the factors to metric computation module 454.

In some aspects, metric computation module 454 may be configured to calculate raw importance metrics based on analytical usage of one or more tables or attributes regarding to the different factors within a period of time (e.g., in the past year but it can be any period of time in the history). Metric computation module 454 may also be configured to normalize these different factors to compute normalized importance metrics (e.g. score) associated with the metadata results based on each factor within the period of time. The computed importance metrics or scores may be transmitted to clustering module 456 in which cluster module 456 may assign and/or cluster metadata components within categories.

In some aspects, clustering module 456 may apply a custom clustering mechanism on these factors or the scores to assign and/or cluster metadata components within categories, including but not limited to, high, medium, low, and/or very low. The categories may be predefined as a user or system specific number in which defining a coarser or finer categorization would be appreciated by a person having ordinary skill in the art. Clustering module 456 may then transmit the clustered metadata (e.g., with assigned importance or score) to sorting module 458.

In some aspects, sorting module 458 may sort the metadata search results utilizing the sorting metric and/or score to prioritize different metadata results and/or resolve conflicts of results within the same cluster/priority. In some aspects, the importance or scores computed from metric computation module may be transmitted to sorting module 458 without being clustered. Soring module 458 may also sort the metadata search results based on the assigned sorting metric and/or score even without a clustering label.

In some aspects, one or more search results after sorting performed by sorting module 458 may be selected for the user search query and the usage history associated with the one or more search results in the database may be updated and stored. The updated usage history may be utilized by ranking engine 450 of metadata retrieval system 100 to perform a new ranking of metadata search results.

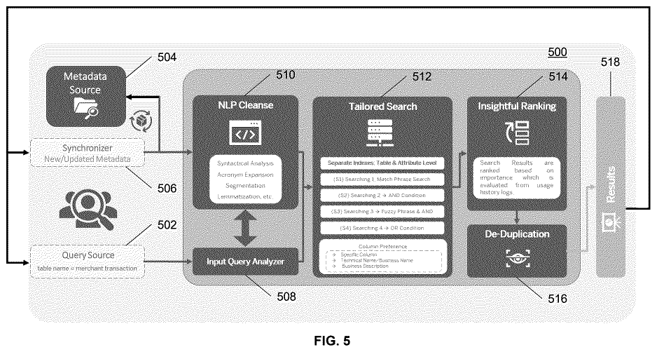

FIG. 5 is an operational framework 500 of a metadata retrieval system 100, according to aspects of the present disclosure. FIG. 5 shall be described as an embodiment of FIG. 1. However, operational framework 500 is not limited to that embodiment.

Operational framework 500 may receive metadata from metadata source 504. In some aspects, query source 502 may be provided by a user into operational framework 500 in which query source 502, for example, may include an input search query as “table name=merchant transaction.” In some aspects, input query analyzer 508 may analyze input search query from query source 502 to comprehend and/or discern type or context of the input search query.

In some aspects, input search query from query source 502, current metadata from metadata source 504, and/or new and update metadata obtained from results 518, after being analyzed by input query analyzer 508, may undergo one or more steps of syntactical analysis within NLP cleanse 510 performed in operational framework 500.

The syntactical analysis may include, but is not limited to, acronym expansion, segmentation, and/or lemmatization, etc. In some aspect, NLP cleanse 510 may be used in operational framework 500 before providing any metadata into the subsequent elastic search repository (e.g., tailored search 512). An input search query may be processed in the same manner as the stored metadata in metadata source 504 but it can also be processed in a different way.

In some aspects, tailored search 512 may be performed in operational framework 500 to obtain search results (e.g., search sequences) after the input search query being undergone syntactical analysis within NLP cleanse 510. Tailored search 512 may be performed in operational framework 500 to organize metadata information into separate elastic search indexes, including but not limited to, Table and Attribute Level. The searching approaches supported by tailored search 512 performed in operational framework 500 may include, but are not limited to, match phrase search, condition search (e.g., AND condition and OR condition), and/or fuzzy phrase search combined with condition search. For specific column search query, tailored search 512 performed in operational framework 500 may also support different column preference including but not limited to specific column, technical name and/or business name, and business description.

In some aspects, insightful ranking 514 may be performed in operational framework 500 to rank the search results from tailored search 512. The metadata search results may be ranked based on importance which is evaluated from usage history logs. In some aspects, the ranked search results obtained from insightful ranking 514 may also be clustered based on an attribute's usage history.

In some aspects, de-duplication 516 may be performed in operational framework 500 after performing insightful ranking 514 to eliminate excessive copies of metadata search results and decrease storage capacity requirements. For example, de-duplication 516 can be run as an inline process as the metadata search results being written into the storage system and/or as a background process to eliminate duplicates after the metadata search results being written to disk. Results 518 obtained after de-duplicating of the metadata search results may be the output of operational framework 500 which may be outputted or displayed to query source 502 and/or stored as a retrieval record in metadata source 504.

In some aspects, synchronizer 506 of operational framework 500 may, within a periodical time, continuously synchronize new and updated metadata into metadata source 504. New and updated metadata may be stored into metadata source 504 or used to update metadata source 504 by synchronizer 506. In some aspects, new and updated metadata may be obtained, generated, and/or manipulated from results 518. In some aspects, results 518 may also be outputted or displayed to query source 502.

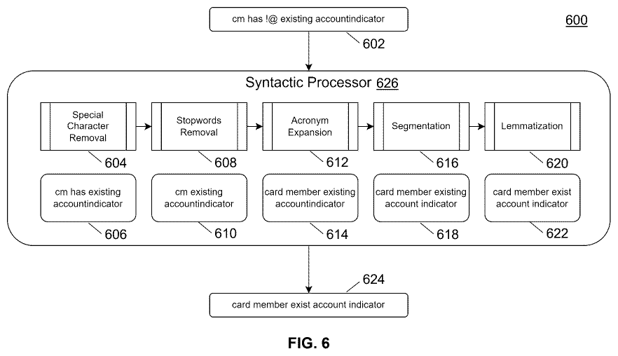

FIG. 6 is an example illustrating a NLP cleanse 600 performed by syntactic processor 626, according to aspects of the present disclosure. FIG. 6 shall be described as an embodiment of NLP cleanse 510 of FIG. 5. However, NLP cleanse 600 is not limited to that embodiment.

In some aspects, user search query 602 may be provided as an input to syntactic processor 626. For example, user search query 602 may be provided as “cm has ! @ existing accountindicator.” In special character removal 604, syntactic processor 626 may remove special characters of user search query 602, resulting in a first updated user search query 606 after special character removal 604. For example, first updated user search query 606 may obtain “cm has existing accountindicator.” In stopwords removal 608, syntactic processor 626 may remove stop words of first updated user search query 606, resulting in a second updated user search query 610. For example, second updated user search query 610 may obtain “cm existing accountindicator.” In acronym expansion 612, syntactic processor 626 may expand acronym of the words of second updated user search query 610, resulting in a third updated user search query 614. For example, third updated user search query 614 may obtain “card member existing accountindicator.” In segmentation 616, syntactic processor 626 may segment the words of third updated user search query 614, resulting in a fourth updated user search query 618. For example, fourth updated user search query 618 may obtain “card member existing account indicator.” In lemmatization 620, syntactic processor 626 may reduce the words of fourth updated user search query 618 to its root form, resulting in a fifth updated user search query 622. For example, fifth updated user search query 622 may obtain “card member exist account indicator.” Fifth updated user search query 622 may then be provided as an output of NLP cleanse 600, e.g., a processed user search query 624 after undergoing one or more syntactical steps performed by syntactic processor 626.

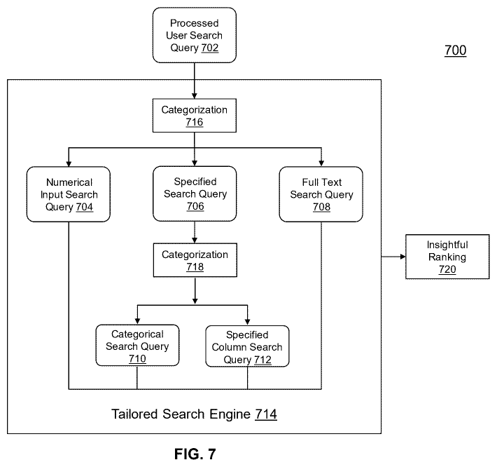

FIG. 7 is an example illustrating a tailored search 700 performed by tailored search engine 714, according to aspects of the present disclosure. FIG. 7 shall be described as an embodiment of tailored search 512 of FIG. 5. However, tailored search 700 is not limited to that embodiment.

In some aspects, processed user search query 702 after undergoing one or more syntactical steps from NLP engine 130 in FIG. 1 may be provided as input of tailored search engine 714. In categorization 716, tailored search engine 714 may direct the searching of relevant metadata based on the type of processed user query 702. Tailored search engine 714 may categorize the relevant metadata into three broad categories after recognizing the type of processed user query 702, including but not limited to, numerical input search query 704, specified search query 706, and/or full text search query 708. In some aspects, in categorization 718, specified search query 706 may be further categorized by tailored search engine 714 into two categories, including but not limited to, categorical search query 710 and/or specific column search query 712. Based on the type of search query type, tailored search engine 714 may direct the search to the appropriate search sequence customized for each type of query. In addition, tailored search engine 714 may transmit the appropriate search sequences to insightful ranking 720.

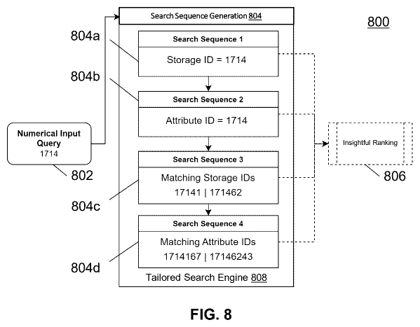

FIG. 8 is an example illustrating a tailored search 800 performed by tailored search engine 808 with numerical input query, according to aspects of the present disclosure. FIG. 8 shall be described as an embodiment of tailored search 512 of FIG. 5. However, tailored search 800 is not limited to that embodiment.

In some aspects, in search sequence generation 804, tailored search engine 808 may generate one or more corresponding search sequences in which the search sequences may include, but are not limited to, one or more related sequences based on numerical input query 802. Tailored search engine 808 may, based on numerical input query 802, then perform searching of at least one of an exact match on storage ID as first preference, an exact match on attribute ID as second preference, a matching storage IDs that begin with the user input as third preference, and/or a matching attribute IDs that begin with the user input as fourth preference.

In some aspects, numerical input query 802 may be provided as “1714” for an input of tailored search engine 808. As directed by numerical input query 802 with “1714”, tailored search engine 808 may generate first search sequence 804a as “Storage ID=1714”, second search sequence 804 b as “Attribute ID=1714”, third search sequence 804c as “Matching Storage IDs 17141|171462”, and/or fourth search sequence 804d as “Matching Attribute IDs 1714167|17146243.” Tailored search engine 808 may sort these generated search sequences based on the preference in which storage ID may be prioritized than attribute ID and/or exact match may also be prioritized than partial match. In addition, tailored search engine 808 may transmit the sorted search sequences to insightful ranking 806.

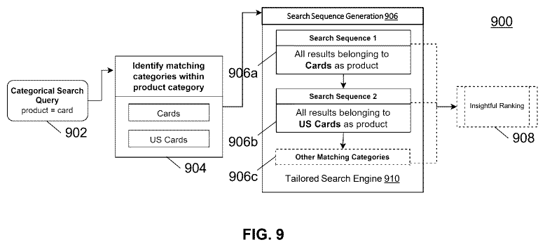

FIG. 9 is an example illustrating a tailored search 900 performed by tailored search engine 910 with categorical search query (e.g., a subclass of specified search query), according to aspects of the present disclosure. FIG. 9 shall be described as an embodiment of tailored search 512 of FIG. 5. However, tailored search 900 is not limited to that embodiment.

In some aspects, categorical search query 902 may be provided as “product=card” for an input of tailored search engine 910. In 904, matching categories may be identified within product category based on categorical search query 902 in which this identification may be performed within input query analyzer 508 in FIG. 5. For example, the categories that may relate to categorical search query 902 may include, but are not limited, to “Cards” and/or “US Cards.” After identification of matching categories related to the input categorical search query, in search sequence generation 906, tailored search engine 910 may generate one or more corresponding search sequences in which the search sequences may include, but are not limited to, one or more related sequences based on categorical search query 902. Tailored search engine 910 may, based on categorical search query 902, then find the matching categories that the user has searched for, and/or display metadata results corresponding to each matching category in order of matching relevancy. As directed by categorical search query 902, tailored search engine 910 may generate first search sequence 906a as “All results belong to Cards”, second search sequence 906b as “All results belonging to US Cards as product”, and/or other matching categories 906c. Tailored search engine 910 may sort search sequences in order of relevancy by the matching categories that the user may have searched for. In addition, tailored search engine 910 may transmit the sorted search sequences to insightful ranking 908

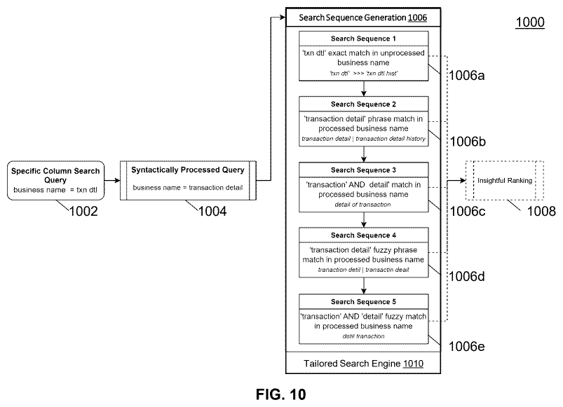

FIG. 10 is an example illustrating tailored search 1000 performed by tailored search engine 1010 with specific column search query (e.g., a subclass of specified search query), according to aspects of the present disclosure. FIG. 10 shall be described as an embodiment of tailored search 512 of FIG. 5. However, tailored search 1000 is not limited to that embodiment.

In some aspects, specific column search query 1002 may be provided as “business name=txt dtl” for an input of tailored search engine 1010. Specific column search query 1002 may be syntactically processed within a NLP cleanse 510 performed in operational framework 500 in FIG. 5 to obtain a syntactically processed query 1004. For example, syntactically processed query 1004 may be provided as “business name=transaction detail.” After syntactical processing, in search sequence generation 1006, tailored search engine 1010 may generate one or corresponding search sequences in which search sequences may include, but are not limited to, one or more related sequences based on syntactically processed query 1004.

In some aspects, tailored search engine 1010 may perform searching of at least one of an unprocessed input query with an exact match in unprocessed column, a processed input query with a phrase match condition in processed column, a processed input query with an AND condition match in processed column, a processed input query with a phrase match in processed column with some spelling mistakes, and/or a processed input query with an AND condition match in processed column with some spelling mistakes. For example, as directed by syntactically processed query 1004 with “business name=transaction detail”, tailored search engine 1010 may generate first search sequence 1006a, by searching for exact match in unprocessed business name, as “txn dtl >>>txn dtl hist.” Tailored search engine 1010 may generate second search sequence 1006b, by searching for phrase match in processed business name, as “transaction detail|transaction detail history.” Tailored search engine 1010 may generate third search sequence 1006c, by searching for AND condition match in processed business name, as “detail of transaction.” Tailored search engine 1010 may generate fourth search sequence 1006d, by searching for fuzzy phrase match in processed business name, as “tranaction detil|transactin deail.” Tailored search engine 1010 may generate fifth search sequence 1006e, by searching for fuzzy match in processed business name, as “detil tranaction.” Tailored search engine 1010 may also work if the user has provided a misspelled input search query. In addition, tailored search engine 1010 may transmit the search sequences to insightful ranking 1008.

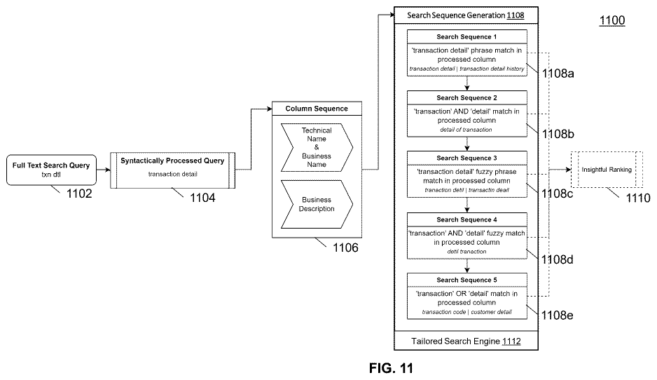

FIG. 11 is an example illustrating a tailored search 1100 performed by tailored search engine 1112 with full text search query, according to aspects of the present disclosure. FIG. 11 shall be described as an embodiment of tailored search 512 of FIG. 5. However, tailored search 1100 is not limited to that embodiment.

In some aspects, full text search query 1102 may be provided as “txt dtl” for an input of tailored search engine 1112. Tailored search engine 1112 may search for the most relevant match based on full text search query 1102. In some aspects, full text search query 1102 may be processed within a NLP cleanse 510 performed in operational framework 500 in FIG. 5 to obtain a syntactically processed query 1104 as “transaction detail.” Tailored search engine 1112 may direct syntactically processed query 1104 to column sequence 1106 with a specific order which may give preference to the technical name and business name, and then may match in the business description. In search sequence generation 1108, tailored search 1100 may then generate one or more corresponding search sequences.

In some aspects, after syntactically processed query 1104 being directed to column sequence 1106, tailored search engine 1112 may perform searching of at least one of a processed input query with a phrase match condition in processed column, a processed input query with an AND condition match in processed column, a processed input query with a phrase match in processed column with some spelling mistakes, a processed input query with an AND condition match in processed column with some spelling mistakes, and/or a processed input query with an OR condition match. For example, as directed by syntactically processed query 1104 with “transaction detail”, tailored search engine 1112 may generate first search sequence 1108a, by searching for phrase match in processed column, as “transaction detail|transaction detail history.” Tailored search engine 1112 may generate second search sequence 1108b, by searching for AND condition match in processed column, as “detail of transaction.” Tailored search engine 1112 may generate third search sequence 1108c, by searching for fuzzy phrase match in processed column, as “transaction detil|transactin deail.” Tailored search engine 1112 may generate fourth search sequence 1108d, by searching for fuzzy match in processed column, as “detil transaction.” Tailored search engine 1112 may generate fifth search sequence 1108e, by searching for match in processed column, as “transaction code customer detail.” Search sequences may be applied on a series of columns with a specific order which may give preference to the technical name and business name and then may match in the business description. In addition, tailored search engine 1112 may transmit search sequences to insightful ranking 1100.

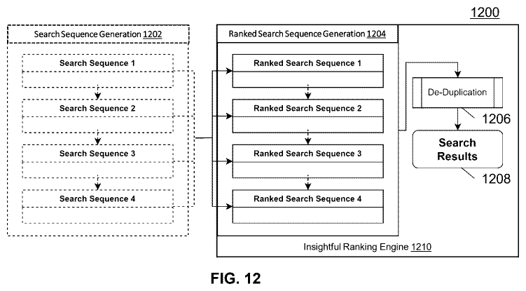

FIG. 12 is an example illustrating an insightful ranking 1200 performed by insightful ranking engine 1210, according to aspects of the present disclosure. FIG. 12 shall be described as an embodiment of insightful ranking 514 of FIG. 5. However, insightful ranking 1200 is not limited to that embodiment.

Search sequences generated from search sequence generation 1202 may be provided as input of insightful ranking 1200. In ranked search sequence generation 1204, insightful ranking engine 1210 may rank the search sequences based on the usage history of the metadata elements of each search sequence to obtain ranked search sequences. Depending on the situation, the ranking performed by insightful ranking engine 1210 could be based on factors (e.g., the metadata elements), including but not limited to, user preference, popularity, performance, or relevance to a search sequence.

In some aspects, insightful ranking engine 1210 may visually present a list of ranked search sequences in order of their relative standing or importance, showing the users which search sequence is ranked highest, second highest, and so on, usually with numerical indicators or clear positional labeling. For example, numbered lists can be used that assign a number to a search sequence, indicating its rank. Star ratings may be used to show relative ranking visually with different numbers of stars representing different levels. Progress bars can also be used to visualize ranking by showing a bar that fills up based on the search sequence's position. In addition, badges or labels such as “Top Rated,” “Bestseller,” or “Highly Ranked” labels can be used to indicate high positions of the ranked search sequence.

Insightful ranking engine 1210 may then perform de-duplication 1206 to those ranked search sequences to obtain search results 1208. De-duplication 1206 may refer to a technique that removes duplicate copies of data to improve storage utilization and reduce costs. De-duplication 1206 may analyze data to identify duplicate byte patterns—it then replaces extra copies the ranked search sequence that points back to the original. De-duplication 1206 can be run as an inline process as the data is being written into the storage system and/or as a background process to eliminate duplicates after the data is written to disk.

In addition, search results 1208 that are frequently accessed may be prioritized by insightful ranking engine 1210, ensuring that users can locate the most relevant information while minimizing search time. That means the search results 1208 which are used or accessed often should be given preference or put at the top of a list when organizing or managing them, as they are likely to be needed more regularly than less frequently accessed items. In particular, when designing user interfaces, frequently used features or options of the search results may often be placed prominently on the screen for an easy user access.

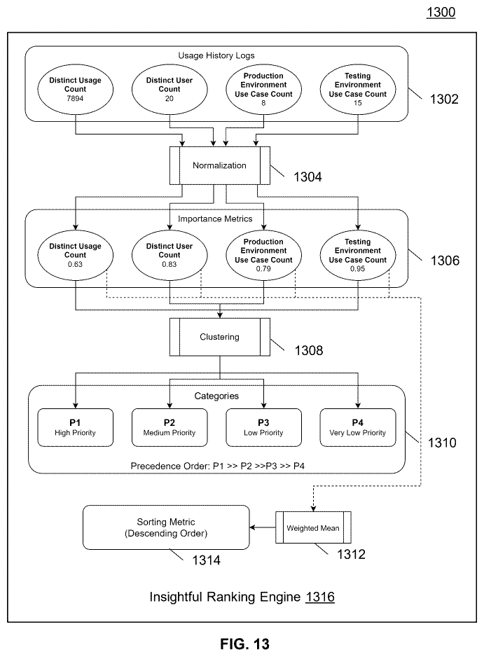

FIG. 13 is an example illustrating an insightful ranking 1300 performed by insightful ranking engine 1316, according to aspects of the present disclosure. FIG. 13 shall be described as an embodiment of insightful ranking 514 of FIG. 5. However, insightful ranking 1300 is not limited to that embodiment.

In some aspects, the metadata search results obtained from tailored search 512 performed in operational framework 500 in FIG. 5 may be assigned importance based on usage history logs of a table or attribute access by users over a specific period of time, which may also be aggregated at the table level. For example, in 1302, a metadata search result directed from a user search query may be associated with usage history logs. Usage history logs may then be utilized by insightful ranking engine 1316 to evaluate the usage of individual table or attributes based on factors, including but not limited to, distinct usage count (4), distinct user count (20), production environment use case count (8), and/or testing environment use case count (15).

In 1304, normalization may be applied by insightful ranking engine 1316 to normalize all four factors based on at least one of a distinct usage count, a distinct user count, a production environment use case count, and/or a testing environment use case count.

In 1306, normalizations may be performed to convert a factor count number to its corresponding importance metrics. For example, a distinct usage with 7894 count may be normalized to a distinct usage ratio with an importance metrics as 0.63. A distinct user with 20 count may be normalized to a distinct user ratio with an importance metrics as 0.83. A production environment use case with 8 count may be normalized to a production environment use case ratio with an importance metrics as 0.83. A testing environment use case with 15 count may be normalized to a testing environment use case ratio with an importance metrics as 0.95.

In 1308, a clustering may be applied by insightful ranking engine 1316 to cluster the normalized usage results based on the importance metrics, associated with each attribute, which may also be aggregated at the table level.

In 1310, the clustering may be applied by insightful ranking engine 1316 to assign and/or categorize each attribute and table, including but not limited to, high priority (P1), medium priority (P2), low priority (P3), and/or very low priority (P4). The categories may be sorted by a precedence order as P1>>P2>>P3>>P4.

In 1312, a weighted mean associated with each metadata search result may be calculated by insightful ranking engine 1316 by at least incorporating the importance metrics of at least one of a distinct usage count, a distinct user count, a production environment use case count, and/or a testing environment use case count. In some aspects, within insightful ranking engine 1316, the weighted mean may be calculated by multiplying the weight (e.g., importance metrics) associated with a particular factor summing all the factors together, and then dividing the product sum by a sum of all weights in the data set. The resulting quotient may be the weighted mean associated with each attribute and table.

In 1314, a sorting metric with a descending order may be applied by insightful ranking engine 1316 to multiple metadata search results by at least sorting the calculated weighted mean associated with each metadata search result in which a list of ranking metadata search results with frequently-accessed items being prioritized may be outputted as results of insightful ranking engine 1316.

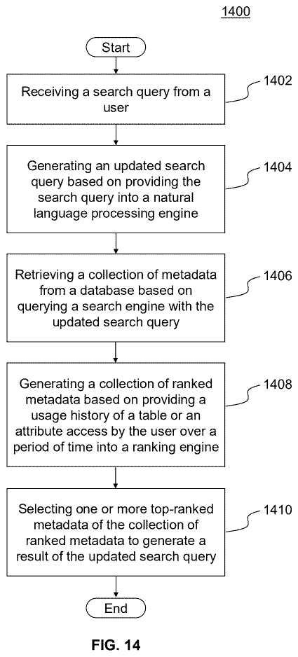

FIG. 14 is a flowchart illustrating a method 1400 for managing and retrieving metadata from an enterprise-wide database, according to aspects of the present disclosure. Method 1400 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 14, as will be understood by a person of ordinary skill in the art.

Method 1400 shall be described with reference to at least FIGS. 1-5. However, method 1400 is not limited to that those example aspects. In 1402, a search query from a user may be received.

In 1404, an updated search query may be generated by at least providing the search query into a NLP engine. The NLP engine may refine textual information of the search query to generate the updated search query. In some aspects, the NLP engine comprises performing at least one of a special character removal, a stop words removal, an acronym expansion, a segmentation, or a lemmatization.

In 1406, a collection of metadata may be retrieved from a database by at least querying a search engine with the updated search query. The search engine may search metadata information that meets one or more criteria identified by the updated search query. In some aspects, the search engine may include, but is not limited to, identifying a type of the updated search query and generating one or more search sequences associated with the updated search query. In some aspects, the identifying a type of the updated search query may include, but is not limited to, categorizing a context or the type of the updated search query to direct the search engine to generate the one or more search sequences based on the context or the type. In some aspects, the type of the updated search query may include, but is not limited to, a numerical input search query, a specified search query, and a full text search query.

In 1408, a collection of ranked metadata may be generated by at least providing, associated with the collection of metadata, a usage history of a table or attribute access by the user over a period of time into a ranking engine. The ranking engine may rank the collection of metadata based on the usage history. In some aspects, the generating the collection of ranked metadata may include, but is not limited to, computing one or more scores associated with the collection of metadata, ranking an element of the collection of metadata based on a ranked version of the one or more scores, and clustering the one or more scores into one or more priority categories. The score may be computed from a usage history of at least a table or an attribute of the collection of metadata by the one or more users within a period of time.

In 1410, one or more top-ranked metadata of the collection of ranked metadata may be selected to generate a result of the updated search query.

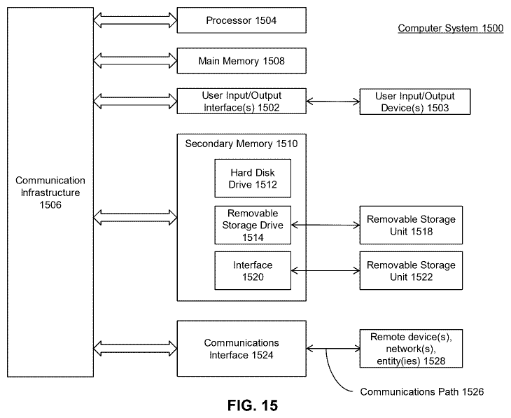

Various aspects may be implemented, for example, using one or more well-known computer systems, such as computer system 1500 shown in FIG. 15. For example, aspects herein using the metadata retrieval system may be implemented using combinations or sub-combinations of computer system 1500. Additionally or alternatively, one or more computer systems 1500 may be used, for example, to implement any of the aspects discussed herein, as well as combinations and sub-combinations thereof. A “module,” as the term is used herein, is a computational element that performs one or more functions according to computer readable instructions stored on one or more memories or other non-transitory computer-readable media.

Computer system 1500 may include one or more processors (also called central processing units, or CPUs), such as a processor 1504. Processor 1504 may be connected to a communication infrastructure or bus 1506.

Computer system 1500 may also include user input/output device(s) 1503, such as monitors, keyboards, pointing devices, etc., which may communicate with communication infrastructure 1506 through user input/output interface(s) 1502.

One or more of processors 1504 may be a graphics processing unit (GPU). In an aspect, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1500 may also include a main or primary memory 1508, such as random access memory (RAM). Main memory 1508 may include one or more levels of cache. Main memory 1508 may have stored therein control logic (i.e., computer software) and/or data.

Computer system 1500 may also include one or more secondary storage devices or memory 1510. Secondary memory 1510 may include, for example, a hard disk drive 1512 and/or a removable storage device or drive 1514. Removable storage drive 1514 may be a floppy disk drive, a magnetic tape drive, a compact disk drive, an optical storage device, tape backup device, and/or any other storage device/drive.

Removable storage drive 1514 may interact with a removable storage unit 1518. Removable storage unit 1518 may include a computer usable or readable storage device having stored thereon computer software (control logic) and/or data. Removable storage unit 1518 may be a floppy disk, magnetic tape, compact disk, DVD, optical storage disk, and/any other computer data storage device. Removable storage drive 1514 may read from and/or write to removable storage unit 1518.

Secondary memory 1510 may include other means, devices, components, instrumentalities or other approaches for allowing computer programs and/or other instructions and/or data to be accessed by computer system 1500. Such means, devices, components, instrumentalities or other approaches may include, for example, a removable storage unit 1522 and an interface 1520. Examples of the removable storage unit 1522 and the interface 1520 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 1500 may further include a communication or network interface 1524. Communication interface 1524 may enable computer system 1500 to communicate and interact with any combination of external devices, external networks, external entities, etc. (individually and collectively referenced by reference number 1528). For example, communication interface 1524 may allow computer system 1500 to communicate with external or remote devices 1528 over communications path 1526, which may be wired and/or wireless (or a combination thereof), and which may include any combination of LANs, WANs, the Internet, etc. Control logic and/or data may be transmitted to and from computer system 1500 via communication path 1526.

Computer system 1500 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 1500 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (Saas), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 1500 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some aspects, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 1500, main memory 1508, secondary memory 1510, and removable storage units 1518 and 1522, as well as tangible articles of manufacture embodying any combination of the foregoing. Such control logic, when executed by one or more data processing devices (such as computer system 1500 or processor(s) 1504), may cause such data processing devices to operate as described herein.

Based on the teachings contained in this disclosure, it will be apparent to persons skilled in the relevant art(s) how to make and use aspects of this disclosure using data processing devices, computer systems and/or computer architectures other than that shown in FIG. 15. In particular, aspects can operate with software, hardware, and/or operating system implementations other than those described herein.

It is to be appreciated that the Detailed Description section, and not any other section, is intended to be used to interpret the claims. Other sections can set forth one or more but not all exemplary aspects as contemplated by the inventor(s), and thus, are not intended to limit this disclosure or the appended claims in any way.

While this disclosure describes exemplary aspects for exemplary fields and applications, it should be understood that the disclosure is not limited thereto. Other aspects and modifications thereto are possible, and are within the scope and spirit of this disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative aspects can perform functional blocks, steps, operations, methods, etc. using orderings different than those described herein.

References herein to “one aspect,” “an aspect,” “an example aspect,” or similar phrases, indicate that the aspect described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it would be within the knowledge of persons skilled in the relevant art(s) to incorporate such feature, structure, or characteristic into other aspects whether or not explicitly mentioned or described herein. Additionally, some aspects can be described using the expression “coupled” and “connected” along with their derivatives. These terms are not necessarily intended as synonyms for each other. For example, some aspects can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary aspects, but should be defined only in accordance with the following claims and their equivalents.

1. A computer-implemented method performed by one or more computing devices, comprising:
receiving a search query from a user;
generating an updated search query by at least providing the search query into a natural language processing (NLP) engine, wherein the NLP engine refines textual information of the search query to generate the updated search query;
retrieving a collection of metadata from a database by at least querying a search engine with the updated search query, wherein the search engine searches metadata information that meets one or more criteria identified by the updated search query;
generating a collection of ranked metadata by at least providing usage history of a table or an attribute access by the user that is associated with the collection of metadata over a period of time into a ranking engine, wherein the ranking engine ranks the collection of metadata based on the usage history; and
selecting one or more top-ranked metadata of the collection of ranked metadata to generate a result of the updated search query, wherein the one or more top-ranked metadata is synchronized into the database to update the usage history associated with the one or more top-ranked metadata.

2. The computer-implemented method according to claim 1, further comprising storing new metadata into the database, wherein the new metadata is searchable by providing a new search query.

3. The computer-implemented method according to claim 1, wherein the NLP engine comprises performing at least one of a special character removal, a stop words removal, an acronym expansion, a segmentation, or a lemmatization.

4. The computer-implemented method according to claim 1, wherein the search engine comprises identifying a type of the updated search query and generating one or more search sequences associated with the updated search query.

5. The computer-implemented method according to claim 4, wherein the identifying comprises categorizing a context or the type of the updated search query to direct the search engine, based on the context or the type, to generate the one or more search sequences.

6. The computer-implemented method according to claim 4, wherein the type of the updated search query comprises a numerical input search query, a specified search query, and a full text search query.

7. The computer-implemented method according to claim 1, wherein the generating the collection of ranked metadata comprises:
computing one or more scores associated with the collection of metadata, wherein a score is computed from the usage history of at least the table or the attribute access by the user within a period of time;
ranking the element of the collection of metadata based on a ranked version of the one or more scores; and
clustering the one or more scores into one or more priority categories.

8. A system, comprising:
a memory configured to store operations; and
one or more processors configured to perform the operations, the operations comprising:
receiving a search query from a user;
generating an updated search query by at least providing the search query into a natural language processing (NLP) engine, wherein the NLP engine refines textual information of the search query to generate the updated search query;
retrieving a collection of metadata from a database by at least querying a search engine with the updated search query, wherein the search engine searches metadata information that meets one or more criteria identified by the updated search query;
generating a collection of ranked metadata by at least providing a usage history of a table or an attribute access by the user that is associated with the collection of metadata over a period of time into a ranking engine, wherein the ranking engine ranks the collection of metadata based on the usage history; and
selecting one or more top-ranked metadata of the collection of ranked metadata to generate a result of the updated search query, wherein the one or more top-ranked metadata is synchronized into the database to update the usage history associated with the one or more top-ranked metadata.

9. The system according to claim 8, wherein the one or more processors are further configured to perform operations comprising:
storing new metadata into the database, wherein the new metadata is searchable by providing a new search query.

10. The system according to claim 8, wherein the NLP engine comprises performing at least one of a special character removal, a stop words removal, an acronym expansion, a segmentation, or a lemmatization.

11. The system according to claim 8, wherein the search engine comprises identifying a type of the updated search query and generating one or more search sequences associated with the updated search query.

12. The system according to claim 11, wherein the identifying comprises categorizing a context or the type of the updated search query to direct the search engine, based on the context or the type, to generate the one or more search sequences.

13. The system according to claim 11, wherein the type of the updated search query comprises a numerical input search query, a specified search query, and a full text search query.

14. The system according to claim 8, wherein the generating the collection of ranked metadata comprises:
computing one or more scores associated with the collection of metadata, wherein a score is computed from the usage history of at least the table or the attribute access by the user within a period of time;
ranking the element of the collection of metadata based on a ranked version of the one or more scores; and
clustering the one or more scores into one or more priority categories.

15. A non-transitory computer-readable storage device having instructions stored thereon, execution of which, by one or more processors, causes the one or more processors to perform operations comprising:
receiving a search query from a user;
generating an updated search query by at least providing the search query into a natural language processing (NLP) engine, wherein the NLP engine refines textual information of the search query to generate the updated search query;
retrieving a collection of metadata from a database by at least querying a search engine with the updated search query, wherein the search engine searches metadata information that meets one or more criteria identified by the updated search query;
generating a collection of ranked metadata by at least providing a usage history of a table or an attribute access by the user that is associated with the collection of metadata over a period of time into a ranking engine, wherein the ranking engine ranks the collection of metadata based on the usage history; and
selecting one or more top-ranked metadata of the collection of ranked metadata to generate a result of the updated search query, wherein the one or more top-ranked metadata is synchronized into the database to update the usage history associated with the one or more top-ranked metadata.

16. The non-transitory computer-readable storage device according to claim 15, wherein the operations further comprise:
storing new metadata into the database, wherein the new metadata is searchable by providing a new search query.

17. The non-transitory computer-readable storage device according to claim 15, wherein the NLP engine comprises performing at least one of a special character removal, a stop words removal, an acronym expansion, a segmentation, or a lemmatization.

18. The non-transitory computer-readable storage device according to claim 15, wherein the search engine comprises identifying a type of the updated search query and generating one or more search sequences associated with the updated search query.

19. The non-transitory computer-readable storage device according to claim 18, wherein the identifying comprises categorizing a context or the type of the updated search query to direct the search engine, based on the context or the type, to generate the one or more search sequences.

20. The non-transitory computer-readable storage device according to claim 15, wherein the operations further comprise:
computing one or more scores associated with the collection of metadata, wherein a score is computed from the usage history of at least the table or the attribute access by the user within a period of time;
ranking the element of the collection of metadata based on a ranked version of the one or more scores; and
clustering the one or more scores into one or more priority categories.
